(19) United States
(12) Patent Application Publication
(10) Pub. No.: US 2016/0164846 A1
(43) Pub. Date: Jun. 9, 2016

(54) METHOD OF DIGITAL IMAGES MANAGEMENT AND A DIGITAL IMAGES MANAGEMENT SYSTEM

(71) Applicants: Daniel R. CASLER, Nanaimo (CA); VERIFIED NETWORK INC., Nanaimo (CA)

(72) Inventor: Daniel Casler, Nanaimo (CA)

(73) Assignee: VERIFIED NETWORK INC., Nanaimo, BC (CA)

(21) Appl. No.: 14/906,130

(22) PCT Filed: Jul. 25, 2014
(86) PCT No.: PCT/CA2014/000594

§ 371 Date: Jan. 19, 2016

(30) Foreign Application Priority Data
Jul. 25, 2013 (CA) 2822174
Sep. 18, 2013 (CA) 2827096

(51) Int. Cl. H04L 29/06; H04N 1/00; H04N 5/225

(52) U.S. Cl. CPC H04L 63/0428; H04N 5/225; H04N 1/00204; H04L 63/0892

(57) ABSTRACT

A method of digital image management is described for a mobile device having both a camera capable of taking digital images and an ability to communicate with the internet. There is an internet schema resident on the Internet and a mobile device schema resident in the mobile device. The data fields of the mobile device schema are updated to correspond with the internet schema whenever the mobile device connects with the internet schema. A graphical user interface resident in the mobile device allows a user to input, into the mobile device schema, metadata descriptive of the subject of a digital image contemporaneously with taking of the digital image. This metadata is independent of the digital image, but linked to the digital image for future recall. The graphical user interface resident in the mobile device also allows the user to upload to the internet schema and grant permission for viewing access.

### FIELD

There is described a method of digital images management for a mobile device having both a camera capable of taking digital images and an ability to communicate with the internet. There is also described a digital images management system in accordance with the method. The term “digital images” has been used, as the images requiring management could be digital photos, digital video or both.

### BACKGROUND

When a user takes digital images today, the user captures the digital images with a camera first, then plugs the camera into a computer to transfer the digital images from the camera to the computer. Once the digital images have been transferred to the computer, they have to be manually sorted and organized.

Collaborating with digital image typically involves emailing digital images to other users or sending the digital images via short message service (SMS) texting. Sending digital images via email or SMS texting is not secure and quickly becomes unmanageable when hundreds of digital images have to be sent per day.

There are some internet services that allow users to take digital images and share them with other users. INSTAGRAM (Trademark) and FACEBOOK (Trademark) are examples of internet services with digital image sharing capability. A user is able to link his or her account to another user's account. Every time the user loads a new image, the linked users are able to see the image.

DROPBOX (Trademark) is a file hosting service. DROPBOX allows users to create a special folder on each of their computers, which DROPBOX then synchronizes so that it the special folder holds the same content regardless of which computer is used to view it.

MITCHELL FASTPHOTO (Trademark) utilizes a firmware based digital camera built by RICOH (Trademark), which allow users to scan a barcode or select data from a pre-defined data list in order to associate data which is stored within the Exchange Image File Format (Exif) data of taken digital images. This metadata becomes part of the digital image.

Existing digital image technologies are not well suited to the needs of business, where any one business in the course of a single month may be required to take thousands of digital images relating to hundreds of different customers. What is required is a digital image sharing network that is better suited to the needs of business.

### SUMMARY

According to one aspect, there is provided a method of digital image management for a mobile device having both a camera capable of taking digital images and an ability to communicate with the internet. The method includes providing an internet schema resident on the internet. The internet schema has multiple data fields that are searchable to extract information based upon a common characteristic found in one of the multiple data fields. The method includes providing a mobile device schema resident in the mobile device. The mobile device schema has multiple data fields that mirror the multiple data fields of the internet schema. The multiple data fields of the mobile device schema are updated to correspond with the multiple data fields of the internet schema whenever the mobile device connects with the internet schema on the internet. The method includes providing a graphical user interface resident in the mobile device that allows a user to input, into the mobile device schema, metadata descriptive of the subject of a digital image contemporaneously with taking of the digital image. The metadata in the mobile device schema is independent of the digital image, but linked to the digital image for future recall. The graphical user interface resident in the mobile device also allows the user to upload, along with each digital image, the metadata linked to the digital image from the mobile device schema to the internet schema. The graphical user interface resident in the mobile device also allows the user to grant permission for one or more collaborators to access selected portions of the internet schema to view selected digital images and the metadata linked to such digital images.

According to another aspect there is provided a digital images management system for a mobile device having both a camera capable of taking digital images and an ability to communicate with the internet. The management system includes an internet schema resident on the internet. The internet schema has multiple data fields that are searchable to extract information based upon a common characteristic found in one of the multiple data fields. The management system also includes a mobile device schema resident in the mobile device. The mobile device schema has multiple data fields that mirror the multiple data fields of the internet schema. The multiple data fields of the mobile device schema are updated to correspond with the multiple data fields of the internet schema whenever the mobile device connects with the internet schema on the internet. The management system also includes a graphical user interface resident in the mobile device that allows a user to a user to input, into the mobile device schema, metadata descriptive of the subject of a digital image contemporaneously with taking of the digital image. The metadata in the mobile device schema is independent of the digital image, but linked to the digital image for future recall. The graphical user interface resident in the mobile device also allows the user to upload, along with each digital image, the metadata linked to the digital image from the mobile device schema to the internet schema. The graphical user interface resident in the mobile device also allows the user to grant permission for one or more collaborators to access selected portions of the internet schema to view selected digital images and the metadata linked to such digital images.

As will hereinafter be described, there are numerous examples of where the above described method of digital image management and digital images management system can be put to practical use in working with collaborators. One type of collaborator is a specialist. For example, a doctor who is a general practitioner can take digital images of a patient and provide access to a specialist selected digital images relating to a potentially cancerous lesion for which a specialist opinion is required. Another type of collaborator includes suppliers, subcontractors and other business to business collaborators. For example, a body shop can take before and after pictures of a customer's damaged vehicle and provide access to a bumper supplier of selected digital images of a damaged bumper for the purpose of securing a correct replacement bumper. On a most basic level, a collaborator may be a customer of a business. On a personal level, collaboration may be required with emergency response personnel, when emergencies arise.

As will hereinafter be further described, there are additional features that can be added to enhance the method and digital image management system. It is preferred that there is a parent to child relationship between hierarchical levels for metadata entry, with a selection on one level defining selections available on a next level. The addition of this feature serves to speed up and simplify data input. For example, if an auto body repair shop selected the category “bumper”, this would automatically create the subcategories “front bumper” or “rear bumper”. If the auto body repair shop selected the category “fender”, this would automatically create the subcategories “front driver side fender”, “rear drive side fender”, “front passenger side fender” and “rear passenger side fender”.

Another enhancement is the use of an electronic notification system. It is preferred that computer generated electronic notifications are sent to collaborating users when new digital images are uploaded to the internet schema based upon the roles and permissions assigned.

The multiple data fields are searchable for extraction of data. For example, hairdressers searching for a hair style to suit their current client could search through all existing clients in an effort to find possible hair styles that would be flattering to their current client. The search would be conducted based upon a data field relating to hair type (fine, coarse) and facial characteristics (high cheek bones).

It should be noted that the internet schema is not homogeneous to all customers. The internet schema is unique to a user group and is reconfigurable to suit the needs of the user group. For example, the internet schema for an auto body repair business would not be the same as the internet schema for medical doctor or a pet supply business. Even as between two auto body repair businesses, the internet schema will be reconfigured over time so that the respective internet schema differ.

A business is one form of user group that uses the internet schema. Within a user group, roles and permissions are assigned to all users in the user group. It is only selected users, within the user group, who are authorized to reconfigure the multiple data fields of the mobile device schema and then upload the mobile device schema to the internet schema to effect a change to the internet schema.

In a business environment, the files of individual customers and individual projects must be kept separate. It is, therefore, preferred that a unique identifier common to the mobile device schema and the internet schema be used for the purpose of grouping digital images relating to individual customers or individual projects of the business.

### BRIEF DESCRIPTION OF THE DRAWINGS

These and other features will become more apparent from the following description in which reference is made to the appended drawings, the drawings are for the purpose of illustration only and are not intended to be in any way limiting, wherein:

FIG. 1 is a first screen shot of an interface resident on a camera.

FIG. 2 is a second screen shot of an interface resident on a camera.

FIG. 3 is a third screen shot of an interface resident on a camera.

FIG. 4 is a fourth screen shot of an interface resident on a camera.

FIG. 5 is a fifth screen shot of an interface resident on a camera.

FIG. 6 is a sixth screen shot of an interface resident on a camera.

FIG. 7 is a seventh screen shot of an interface resident on a camera.

FIG. 8 is an eighth screen shot of an interface resident on a camera.

FIG. 9 is a ninth screen shot of an interface resident on a camera.

FIG. 10 is a tenth screen shot of an interface resident on a camera.

FIG. 11 is an eleventh screen shot of an interface resident on a camera.

FIG. 12 is a twelfth screen shot of an interface resident on a camera.

FIG. 13 is a thirteenth screen shot of an interface resident on a camera.

FIG. 14 is a fourteenth screen shot of an interface resident on a camera.

FIG. 15 is a fifteenth screen shot of an interface resident on a camera.

FIG. 16 is a sixteenth screen shot of an interface resident on a camera.

FIG. 17 is a schematic overview of the relationship between the interface resident on the camera and a parallel internet based digital image management system.

FIG. 18 is a schematic diagram of a digital image sharing network for business.

### DETAILED DESCRIPTION

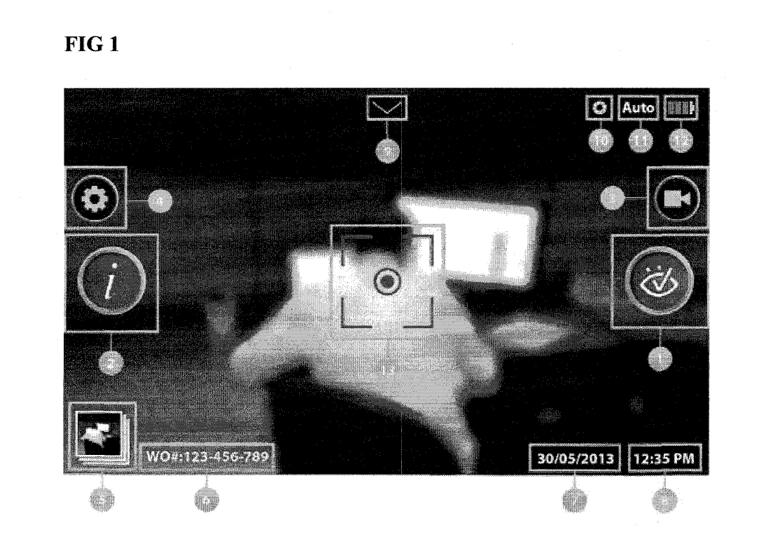

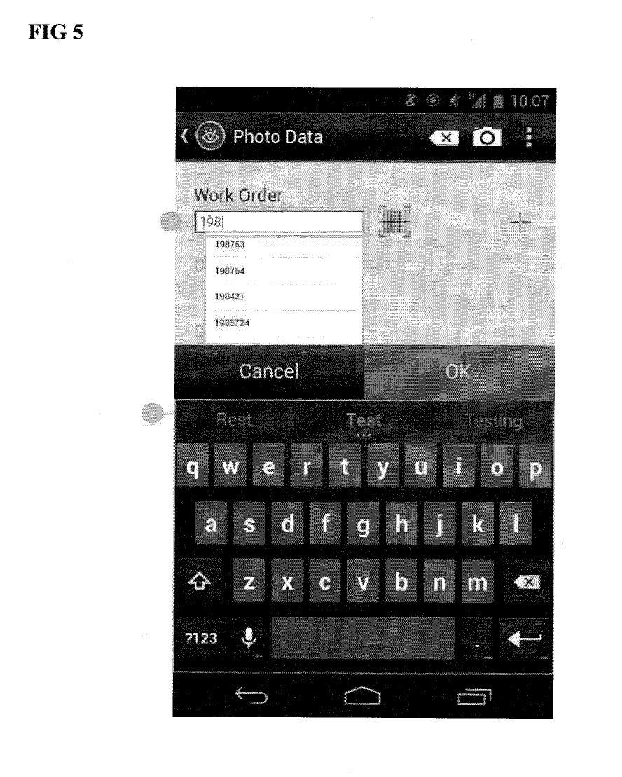

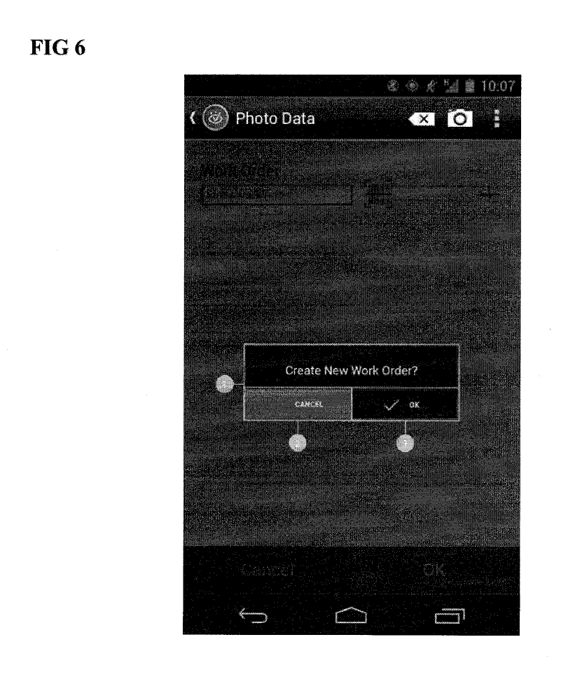

The method and digital image management system will now be described with reference to FIG. 1 through 18.

### Structure and Relationship:

A critical aspect of the description which follows is the term “metadata”. In a broad sense “metadata” is data relating to data. In this context “metadata” is data relating to a particular digital image and, more particularly, data describing the subject matter of what is depicted in the particular digital image. For example, a picture of the passenger side front fender of a specific customer's car.

The method has application to any mobile device having both a camera capable of taking digital images and an ability to communicate with the internet. This includes a variety of devices, the most common at the present time being smart phones (such as the phones sold by Apple Corporation under the Trademark iPhone) and tablet computers (such as the computers sold by Apple Corporation under the Trademark iPad).

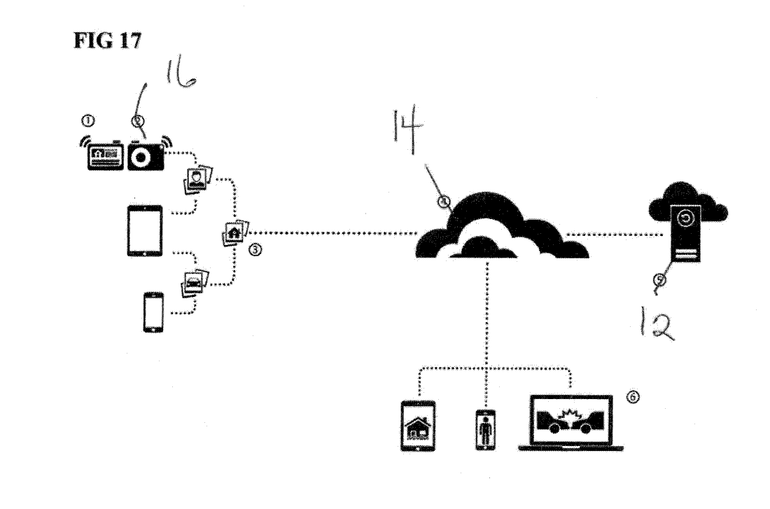

Referring to FIG. 17, the method involves providing an internet schema (depicted as server 12) resident on the internet (depicted as cloud 14). The internet schema has multiple data fields that are searchable to extract information based upon a common characteristic found in one of the multiple data fields. The method also includes providing a mobile device schema resident in the mobile device 16. The mobile device schema has multiple data fields that mirror the multiple data fields of the internet schema. The most common form of schema would be a database. However, the term “schema” has been used as there are various architectures that could be used to deliver the same result that are not technically a “database”.

An important and highly desirable feature is that the multiple data fields of the mobile device schema are updated to correspond with the multiple data fields of the internet schema whenever the mobile device connects with the internet schema on the internet. It is important to understand that it is the data fields that are updated and not data resident in the data fields. The uploading of any data, is menu driven and does not occur automatically.

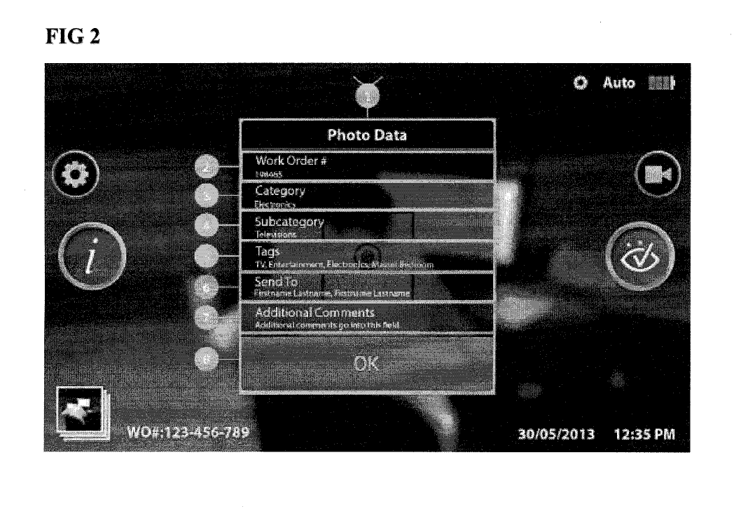

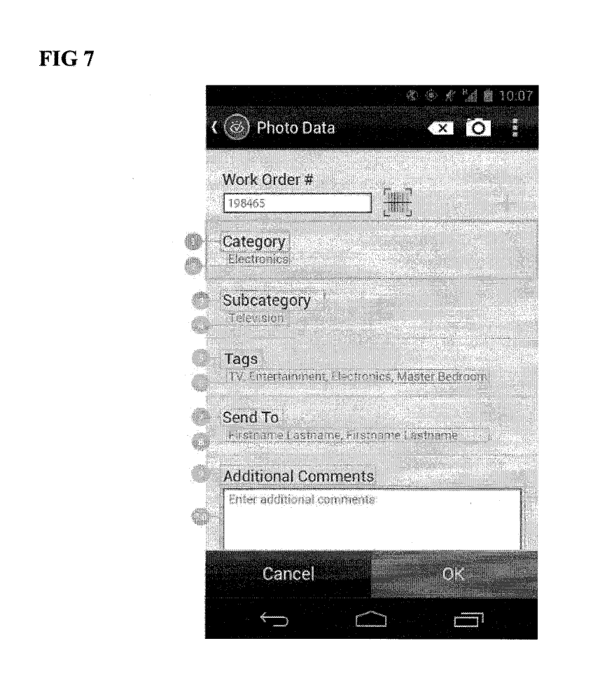

Another important and highly desirable feature is a graphical user interface resident in the mobile device. An early version of the graphical user interface has been illustrated in FIG. 1 through FIG. 16. Referring to FIG. 2 and FIG. 7, this graphical user interface allows a user to input, into the mobile device schema, metadata descriptive of the subject of a digital image contemporaneously with taking of the digital image. It is important to note that the metadata in the mobile device schema is maintained independent of the digital image, but linked to the digital image for future recall.

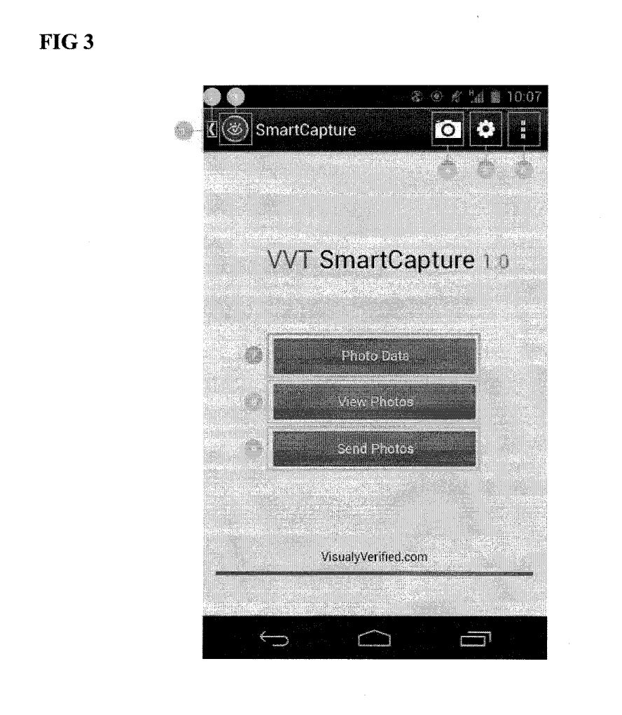

Referring to FIG. 3, the graphical user interface resident in the mobile device also allows the user to upload, along with each digital image, the metadata linked to the digital image from the mobile device schema to the internet schema (using the Send Photos button).

Referring to FIG. 2 and FIG. 7, the graphical user interface resident in the mobile device also allows the user to grant permission for one or more collaborators to access selected portions of the internet schema to view selected digital images and the metadata linked to such digital images (by completing the “send to” field).

Referring to FIG. 1 through 16, these figures are screen shots of graphical user interface 18 resident in camera 100 capable of taking digital images that allows a user to enter metadata regarding the subject matter of the digital image, contemporaneously with the taking of each digital image. The metadata entered, does not become part of the image itself, but becomes and remains linked to that digital image. The use and utility of this interface will become apparent when discussed in the context of an example under the heading of “Operation” below.

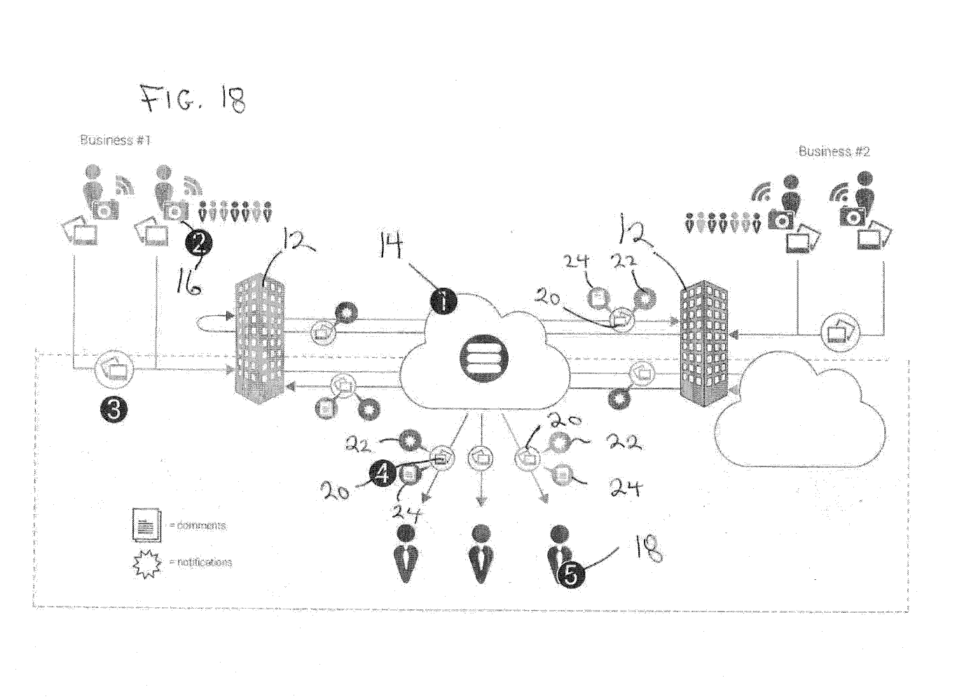

Referring to FIG. 18, internet server 12 can be located on premises or in a remote locations such as a datacentre. Internet servers 12 are connected to the internet 14 via Internet Protocol (IP). Where authorized collaborators 18 can access the digital images 20 from any internet enabled device from anywhere in the world in real time.

As described above, there are two aspects to the digital image management system. The first or core components is a mobile application that can reside on any smartphone or smart camera. The second component is a parallel Internet based management system. The mobile application provides a graphical user interface allowing users to define data concurrently with taking digital images. Data can include a work order, categories, tags, comments or any other type of user definable data. The mobile application allows users to take digital images, which are linked to the user defined data, as well as transmit captured digital images and their corresponding data to the Internet based management system. Digital images can also be viewed and managed from within the mobile application.

When digital images are saved to the cameras/smartphones file system by the mobile application, a unique identifier is assigned for the work, patient ID, folio number or any other relevant unique identifier to the industry the application is being used in. Category and sub category folders are provided within the parent directory (unique identifier). This allows any user to plug in a smartphone or a digital camera and have digital images automatically sorted and organized based on the data they defined within the mobile application. No longer do users see one directory with all of their digital images. This saves tremendous time when accessing and managing digital images from a local file system.

The data fields that users can assign to digital images can be dynamically controlled from the Internet based management system. A new category, tag, contact or any other type of data can be added, edited or deleted and all connected devices running the mobile application will be up-dated in real time. Existing firmware based systems require sending SD memory cards to clients and having them manually update their cameras. This can take weeks or even months to have an entire team using consistent data.

Within the mobile application, authorized user have the ability to add data fields such as categories, tags, contacts or any other user definable data directly from the mobile application. This allows users in the field to be dynamically adding, edited or deleting user definable data, which can be automatically synchronized across hundreds of devices running the mobile application in real-time.

The Internet based management system allows authorized users to access and manage digital images taken. Digital images can be accessed by a unique batch identifier such as a work order or patient id, category, tag, etc. The Internet based management system allows users to view, edit, or delete digital images or their corresponding data. The Internet based management system allows authorized users to manage all connected devices running the mobile application and perform such functions as disabling devices remotely. Being an Internet based management system, users can grant access to other users so they can access individual digital images, batches of digital images or an entire system of digital images. When digital images are received from the mobile application by the Internet based management system, any contacts that were associated to the digital images as requiring access to the digital images, these contacts are automatically notified via email, SMS or system notification with the digital images or alternatively a uniform resource locator (URL) to access the digital images within the Internet based management system. Referring to FIG. 18, digital images are identified by reference numeral 20, electronic notifications are identified by reference numeral 22 and metadata including comments are identified by reference numeral 24.

### Operation:

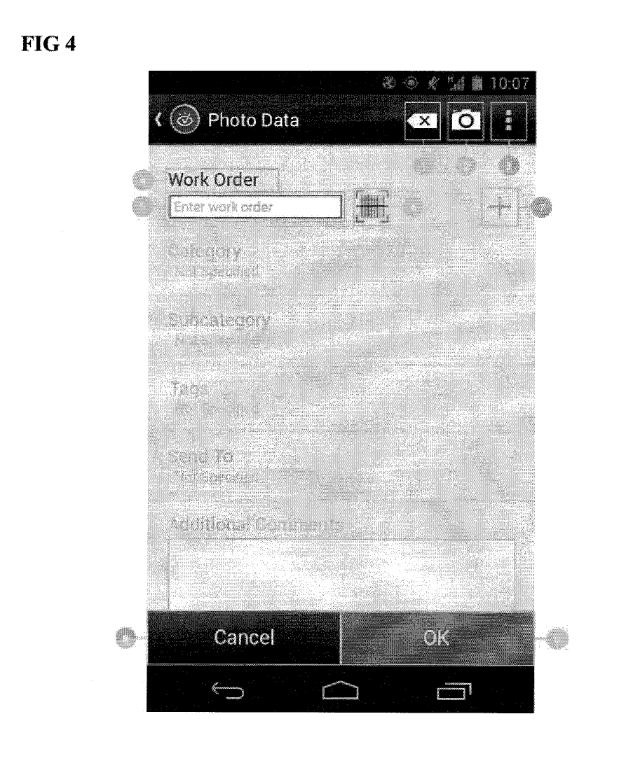

Referring to FIG. 1, a camera control interface allows users to take digital images, manage camera settings as well as enter data. Referring to FIG. 2, the information screen is a quick way of viewing the data settings for the digital images which are being taken. Referring to FIG. 3, the main screen allows the user to navigate to all parts of the application. The Application Icon in the top left should always return the user to this screen when touched. Referring to FIG. 2 the Digital image Data Screen is where users can apply data to the digital images they have taken. “Work Order”, “Category”, “Subcategory”, “Tags”, “Send To” and “additional comments” data should be stored on the local device to be uploaded to the interne server. It will be appreciated that the categories and subcategories may differ with the environment. An auto body repair shop may generate work order numbers which identify a particular repair job. The “Category” may be “fender” to indicate a damaged fender. The “subcategory” may be “passenger side front fender” to indicate which fender is damaged. There is a parent-child relationship between the Categories and the Subcategories. Once the Category is selected, the Subcategory is automatically determined, subject to a new Subcategory being added by an authorized user. The “Tags” may trigger review by a supervisor when a specified number of hours have spent on repairs. The “Send to” could be notifications going to the supervisor, the insurance adjuster, and the owner of the car. The “additional comments” could relate to notes on reuse and reinstall of certain components from the car that appear not to have been damaged. Having this data stored on the local device allows the device to work in an “offline” environment. Referring to FIG. 4 through FIG. 7, the “Work Order” can be automatically assigned by the camera, obtained through barcode scanning or manually input. When a barcode is scanned, the data retrieved from the barcode should automatically appear in the “Work Order” field. When creating a new Work Order, the next available, unused Work Order should be automatically generated, after the user confirms the dialog. The Work Order field needs to verify that the user inputted Work Order is valid. If the Work Order is valid the other data field options should become available. If the Work Order is invalid, the inputted value should be displayed in red. When a user begins inputting a Work Order, auto-complete should match what the user is typing to available possibilities. Only active Work Orders should be available for auto-complete. A barcode scanner may be incorporated into the device. The purpose is to scan a barcode and capture the data contained. The captured data should be inputted into the Work Order Field on the Digital image Data Screen. Every time a barcode is scanned, the value should be checked to ensure it is a valid barcode. This should be checked against the local device, which synchronizes with the master database. Scanning should be automatic without the user having to touch the screen. The scanner should work in both horizontal and vertical mode. If a scanned barcode is invalid, a dialog should appear and notify the user. The user should be able to either cancel out of the screen (and return to the Digital image Data Screen) or select rescan (and then scan another barcode).

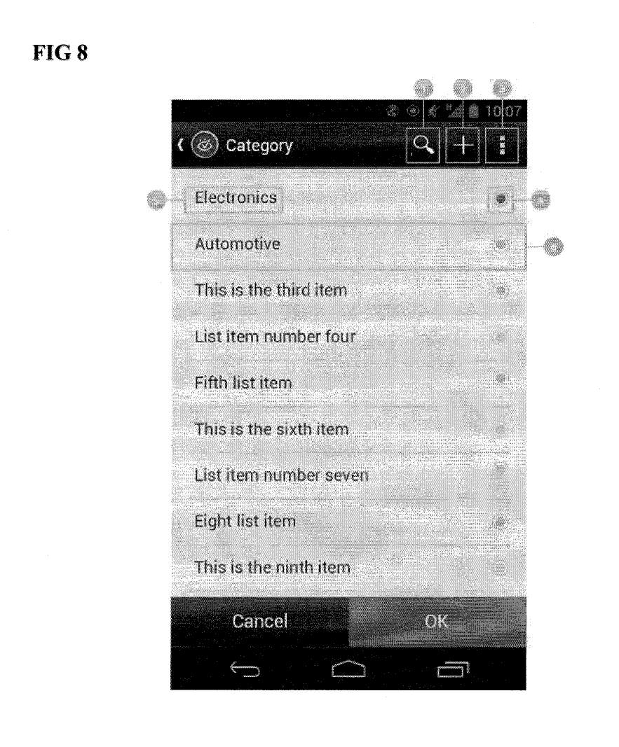

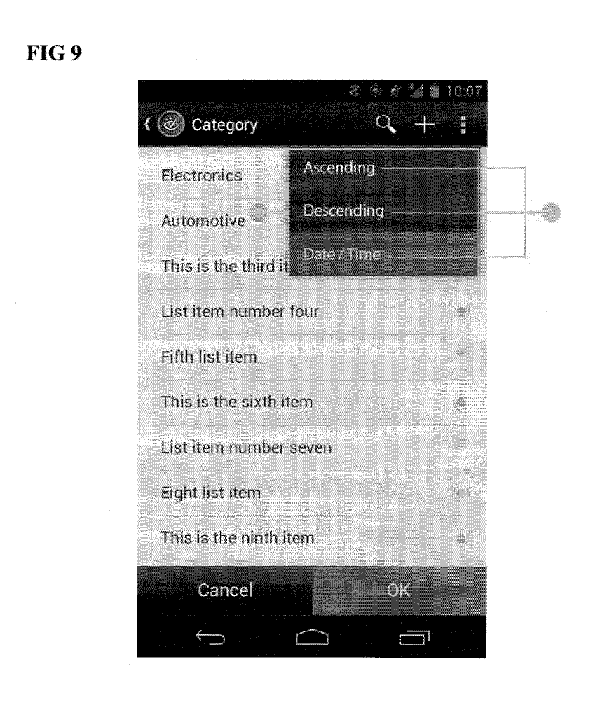

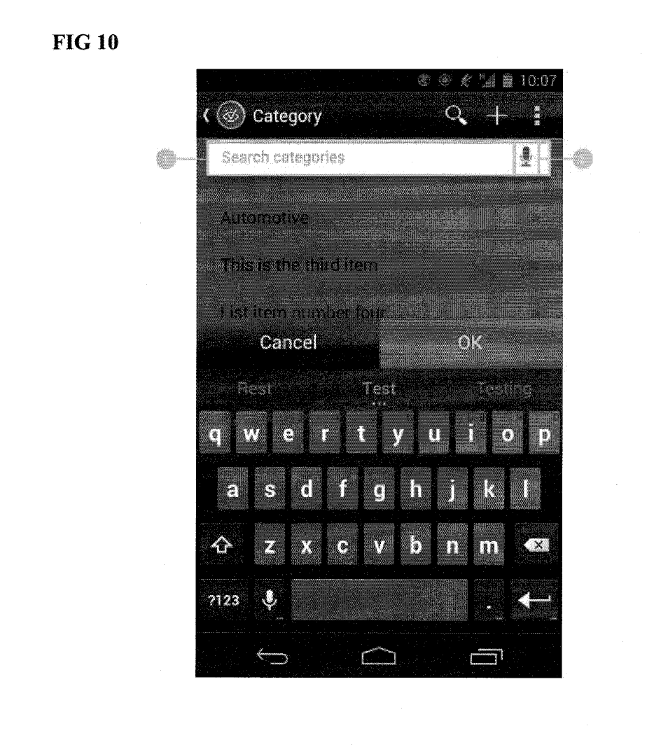

Referring to FIG. 8, FIG. 9 and FIG. 10, a category may be entered. Once the category is entered, input data may be sorted and searched by category. In the example illustrated, the user has categories of “electronics” and “automotive” to choose from, among others. Referring to back to FIG. 7, in the example illustrated the category was “electronics” for the work order in question.

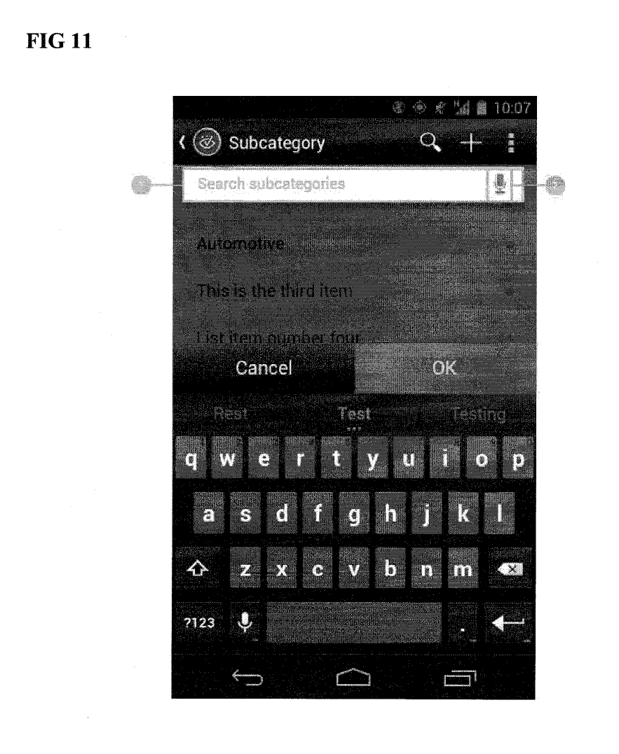

Referring to FIG. 7, a sub-category may be entered. In the example illustrated, “television” was the sub-category under the “electronics” category for the work order in question. Referring to FIG. 11, input data may be sorted and searched by sub-category, just as it was capable of being sorted and searched by category.

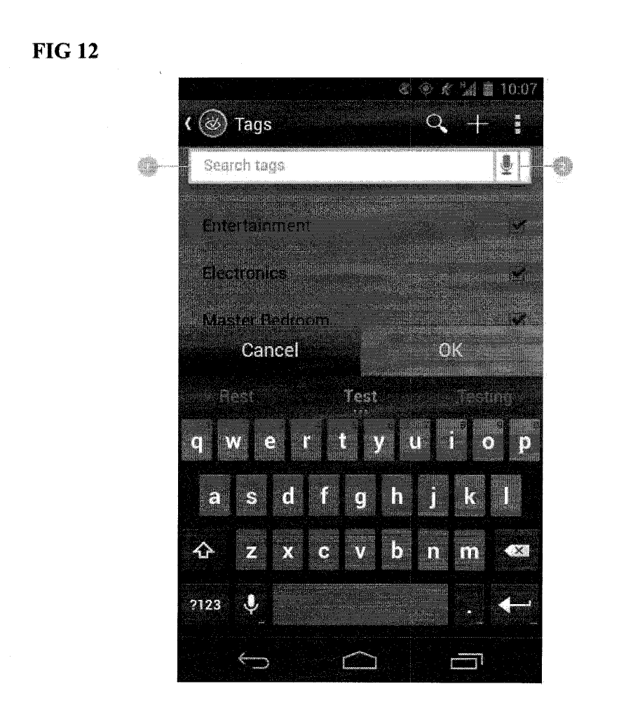

Referring to FIG. 7, it is also possible to add words as search tags. In the example illustrated in FIG. 7, a number of search tags were applied, including “TV”, “Entertainment”, “Electronics”, and “Master bedroom”. Referring to FIG. 12, input data may be sorted and searched by search tags, just as it was capable of being sorted and searched by category and sub-category.

Referring to FIG. 7, where the category, sub-category and search tags do not provide enough information, there is also a data field provided into which the user may insert additional comments as may be required as context to the digital image.

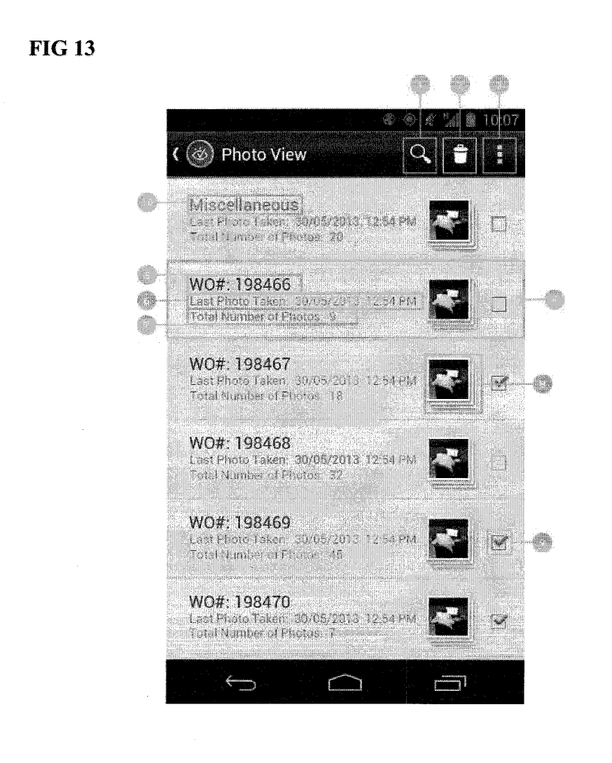

Referring to FIG. 13, all digital image are saved in folders according to work order. In the example illustrated, it can be seen that the folder for work order 198466 has 9 digital images, the folder for work order 198467 has 18 digital images, the folder for work order 198468 has 32 digital images, the folder for work order 198469 has 45 digital images, and the folder for work order 198470 has 7 digital images. It will be understood that each digital image has linked to it data from the above described data fields of category, sub-category, search tags and, as required, additional comments.

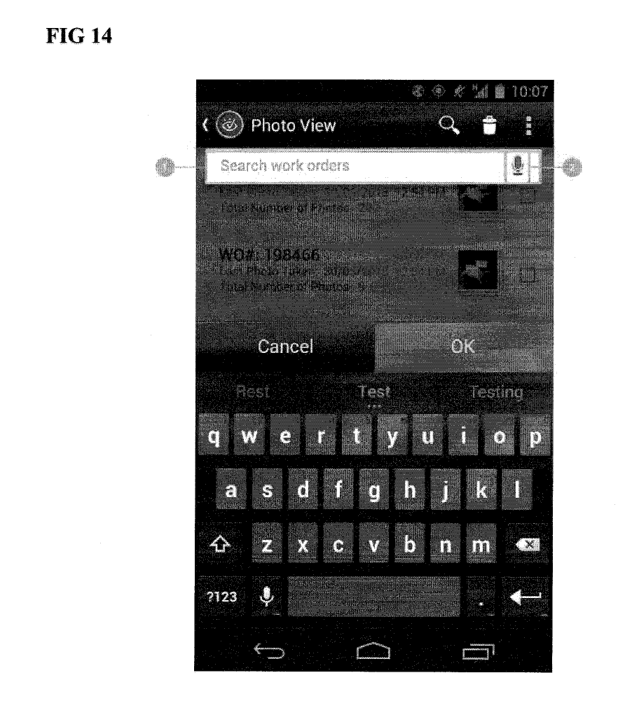

Digital images which are either accidentally taken without having a work order assigned are stored in a folder called Miscellaneous. The miscellaneous folder is a safeguard against operator error, in neglecting to assign the applicable work order number at the time of taking a digital image. Referring to FIG. 14, to locate digital images the user would normally search by work order number to locate the applicable folder. Of course, digital images to which a work order was accidentally not assigned can be located in the Miscellaneous folder.

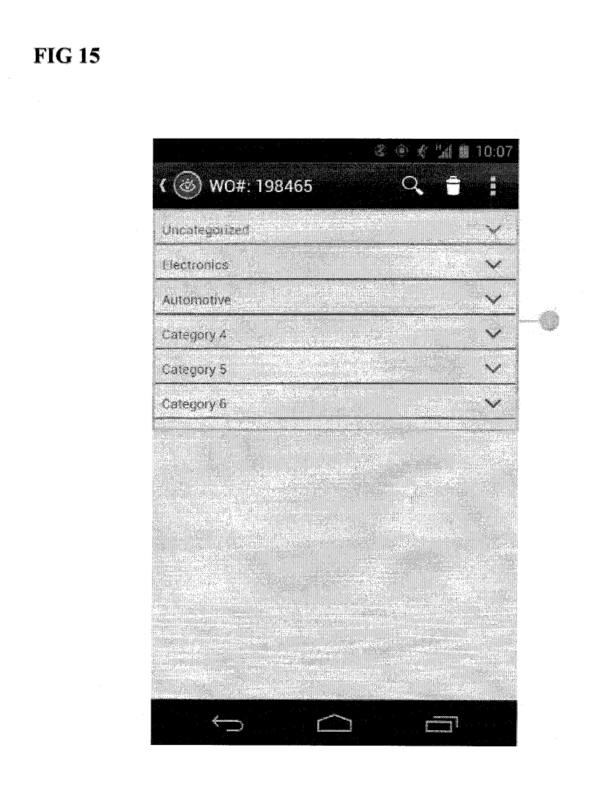

Referring to FIG. 15, in the folder for the work order digital images are grouped by category. In the example illustrated for work order 198465 the categories include “electronics” and “automotive”, among other categories. Any digital images which have accidentally or intentionally not been assigned a category in relation to that work order are grouped together as “uncategorized”. It will be appreciated that the digital images under each category will, in turn, be grouped by sub-category. It will also be appreciated that the organizational hierarchy could differ, and that what is illustrated is merely a preferred arrangement due to its simplicity and ease of implementation in a number of different environments.

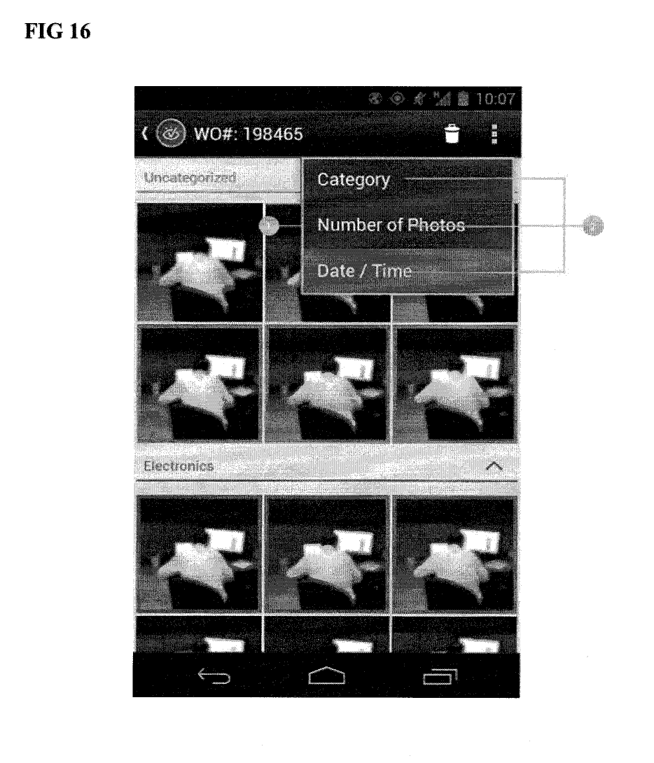

Referring to FIG. 16, there is illustrated how the digital images are displayed. By clicking on an individual digital image, the digital image may be viewed in a full screen view. By clicking on the linked data icon, linked data may be viewed.

At present, common automated digital image management solutions utilize metadata such as EXIF file tags, which requires digital image management to employ cumbersome metadata extraction processes. This form of metadata (EXIF) is difficult to manage due to the limited amount of data which can be assigned to an individual digital image file. The EXIF format is time consuming and labour intensive (operationally expensive) from a technology standpoint as well as from a workflow perspective.

By storing corresponding digital image information in a database or other schema—rather than within the digital image “source code” itself (as per EXIF technology), the digital image files can be catalogued in a much more efficient and effective manner. Key advantages include the ability to attach considerably more data (potentially limitless) to each individual digital image. Dramatic improvements to search functionality and security, as well as reduced file sizes are immediately achievable benefits. In addition, many new and exciting opportunities become viable as this new method will quickly replace the older metadata process due to the increased capacity and flexibility to append multiple and even very large data sets linked to individual digital images.

Concurrent to how data is linked to digital images, the advent of Android-based camera technology allows mobile digital image capture and documentation applications. These new applications make it possible for clients to employ user-friendly interfaces which permit new data input or linking to significant amounts of existing data concurrently with the actual taking of a digital image.

User-defined data, such as categories or tags, can also be dynamically generated and managed. For example, a list of contacts can be maintained and all Smart Cameras connected within the target workflow process would share the same list of contacts and receive the same remote updates when desired and implemented by the project workgroup administrator. This is in contrast with existing metadata-based digital image capture devices, such as RICOH cameras, that require the shipping of new SD memory cards to every camera to enable system firmware updates. This necessity slows the ability to manage change and ultimately adversely impacts entire process efficiencies.

The shift from 802.11 Wi-Fi to 4G LTE broadband cellular connectivity in conjunction with advanced database architecture gives managers better web based tools to manage digital images. The overall system effectively creates an opportunity to improve productivity and respond to rapidly changing business demands, thereby accelerating business innovation and growth.

The digital image management system is highly customizable and is capable of being rapidly deployed in any industry. It's been developed for industries that take, in some cases, tens of thousands of digital images a day. Industries which require potentially hundreds of users collaborating, defining data for digital images, taking digital images and having those digital images sent in real-time through Wi-Fi or cellular Internet to a centralized, Internet based location for processing, management and collaboration. The system is designed to be rapidly customizable for any workflow in any industry with little effort and time.

One example of where this technology may be employed is in the area of healthcare. Physicians are able to take pictures of patients using the mobile application by defining a unique patient identification number and then specifying the type of ailment and any other relevant data. Once the physician has taken digital images of the patient, the digital images are automatically transferred to the internet based digital image management system where they are processed and made available for management. If the physician identified other users who required access to the digital images, those users would automatically be notified via email, an SMS message or by a system notification.

Another example of where this technology may be employed is in the area of construction. Within the construction industry each project can have hundreds or thousands of deficiencies. With this technology, users can take digital images of deficiencies, describe the deficiency using categories, tags or other user definable data as well specify the sub-trades or contacts that need to be notified of the deficiency. Once digital images have been taken and sent to the internet based digital image management system for processing, all sub-trades and selected contacts would be automatically notified via email, SMS or system notification of the deficiency(s) along with the corresponding digital images. Notified parties can also access the management system in order to look at the digital images. Additional functionality to approve work or flag work as completed can be done. Using a traditional digital camera for the above scenarios would result in a significant amount of time and resources being spent sorting, organizing and managing digital images, making it simply not viable.

Another example of where this technology may be employed is in the insurance industry. In the insurance industry, insurance agents or insurance adjusters travel to residential, business or any other location where third party digital image documentation is required. For example, an insurance agent could document a person's residence and all their assets in case of a disaster. Or, if a disaster has taken place, an insurance adjuster could document damage.

A digital image sharing network will now be described with reference to FIG. 18.

### Structure and Relationship of Parts:

A business user registers and builds a list of collaboration contacts. The system allows the business user to select a unique identifier (such as a file number) for a single or batch of digital images stored in a digital file and inputs basic identification data. Once the identification data has been in-putted, a user creates a collaboration user profile for the digital file by selecting from the list of collaboration contacts, those of the collaboration contacts the business user wishes to have access to the digital images for the purpose of this particular collaboration. Once the digital images are transferred to the master database on the interne, an email as well as system notifications are sent to the collaborating users advising them that new digital images have been assigned to them. Collaborating users access the digital file containing the digital images through a secure collaboration portal in the form of a web interface. The whole process is safe, secure and confidential. Only authorized users ever have access to assigned digital images.

When digital images are assigned to first time collaboration users, the first time collaboration users are prompted to create a user account (register) in order to view the assigned digital images. This ensures there is no anonymous access to user assigned digital images.

### Examples of Applications

### Medical

Currently, patients have to wait 15-months or more to see a dermatologist on a referral from their general practitioner. Doctors estimate that 80%-90% of dermatology related referrals could be done remotely using pictures. Within the medical industry digital images are rarely used and they are almost never used for collaborative purposes. The reason being is, there is no safe, secure and confidential method of sharing digital images. In addition, doctors who are general practitioners see a lot of patients. The average doctor sees between 30 and 50 patients per day, which equates to thousands of digital images per month. It would be extremely time consuming for a physician to sort and organize that many digital images per month. The proposed digital image sharing network enables general practitioners in the medical professional to efficiently use digital images as tool for collaboration with specialists.

### Construction

It is good practise to document construction projects using digital images from start to finish. This creates a record of construction progress, clearly showing what work was done and when. There is also a need to share selected digital images with sub-trades working on completion of specific aspects of the projects, especially relating to deficiencies. The proposed digital image sharing network enables the efficient use digital images as a collaboration tool with sub-trades working on construction projects.

### Automotive Collision Repair

Currently, automotive collision repair centers document vehicle damage using digital images for insurance companies. Digital images are a method of visually communicating to insurance companies during the estimation process, what the extent of damage is to vehicle. Automotive collision repair centers also need to provide digital images as method of proving what work was done when repairing a vehicle in order to receiving payment from the insurance company.

One of the largest losses of revenue within the automotive collision industry is parts that are orders that when delivered, are the incorrect part. This happens every day in automotive collision repair centers throughout North America and can cost thousands of dollars a month in lost revenue as well as affecting the shops cycle time with insurance companies. When a wrong part shows up, the vehicle cannot be repaired. In many cases a vehicle could be on a hoist, which could mean the vehicle has to now wait for one to two days before the repair process can continue. This effect all other vehicles in the repair queue. It also effects rental car costs and other costs associated with delay. Many parts are near identical expect for minor differences. When a part is supplier which is incorrect, it is due to problems accurately communicating a description of the part between an automotive collision repair center and a parts supplier. Most of the time this can be avoided if a digital image is involved. A digital image can clearly communicates what the part looks like.

Currently, automotive repair collision repair centers can take digital images and email them to suppliers. This is time consuming and inefficient. Because of this, most automotive collision repair centers do not use digital images when ordering parts. A busy shop could need to take hundreds and in some cases thousands of digital images per week. If collision repair centers could communicate/collaborate using digital images on the majority of vehicle repairs, quickly and easily, a tremendous amount of money could be saved by the automotive collision repair center as well as by the suppliers. The proposed digital image sharing network enables the efficient use digital images as a collaboration tool with part supplies to the automotive repair industry.

### Hair and Beauty

Hair salons around the World today use written notes as part of a client file in order to document the work that was done for clients. This work includes haircuts, hair colouring, and foils used. Written notes contain all of the details, so that when a client wishes to recreate a style the Hair Stylist is able to do so. The method proposed would allow a hair stylist to capture digital images of the client to supplement any written notes. Furthermore, the hair styles would be searchable by category and subcategory for use in searching for styles suitable for persons with particular hair type and facial type.

### Emergency Services

The resources of emergency services personnel working for the fire department, police department and ambulance authorities are sometimes stretched to the limit. In such cases, supervisors must set priorities as to the order in which calls for assistance will be answered. The supervisor must also determine that amount and type of equipment to be sent. The above described method can be used by supervisors to set those priorities. The source of the digital images can be a first responder who is the first to reach the scene or even someone already at the scene. For example, a digital image of an injured person may give an ambulance supervisor an indication as to whether the injury is not life threatening and, as such, can be placed lower on the list of priorities. Similarly, a digital image of a house fire may be provide a fire department supervisor with an indication whether a ladder truck is required or whether the fire can be handled with a smaller vehicle.

In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be one and only one of the elements.

The scope of the claims should not be limited by the illustrated embodiments set forth as examples, but should be given the broadest interpretation consistent with a purposive construction of the claims in view of the description as a whole.

What is claimed is:

1. A method of digital image management for a mobile device having both a camera capable of taking digital images and an ability to communicate with the internet, the method comprising:
providing an internet schema resident on the internet, the internet schema having multiple data fields that are searchable to extract information based upon a common characteristic found in one of the multiple data fields;
providing a mobile device schema resident in the mobile device, the mobile device schema having multiple data fields that mirror the multiple data fields of the internet schema, the multiple data fields of the mobile device schema being updated to correspond with the multiple data fields of the internet schema whenever the mobile device connects with the internet schema on the internet;
providing a graphical user interface resident in the mobile device that allows a user to:
input, into the mobile device schema, metadata descriptive of the subject of a digital image contemporaneously with taking of the digital image, the metadata in the mobile device schema being independent of the digital image, but linked to the digital image for future recall;
upload, along with each digital image, the metadata linked to the digital image from the mobile device schema to the internet schema; and
grant permission for one or more collaborators to access selected portions of the internet schema to view selected digital images and the metadata linked to such digital images.

2. The method of claim 1, wherein an electronic notification system is provided with computer generated electronic notifications automatically being sent to the one or more collaborators upon a new digital image being uploaded.

3. The method of claim 1, wherein there is a parent to child relationship between hierarchical levels for metadata entry, a selection on one level defining selections available on a next level.

4. The method of claim 1, wherein the internet schema is unique to a user group and is reconfigurable to suit the needs of the user group.

5. The method of claim 4, wherein roles and permissions are assigned to all users in the user group and selected users within the user group are authorized to reconfigure the multiple data fields of the mobile device schema and then upload the mobile device schema to the internet schema to effect a change to the internet schema.

6. The method of claim 4, wherein the user group is a business.

7. The method of claim 6, wherein a unique identifier common to the mobile device schema and the internet schema is used for the purpose of grouping digital images relating to individual customers or individual projects of the business.

8. The method of claim 5, wherein computer generated electronic notifications are sent to users of the user group when new digital images are uploaded to the internet schema based upon the roles and permissions assigned.

9. The method of claim 6, wherein the one or more collaborators includes a customer of the business.

10. The method of claim 6, wherein the one or more collaborators includes suppliers, subcontractors and other business to business collaborators of the business.

11. The method of claim 1, wherein the one or more collaborators include emergency response personnel.

12. The method of claim 1, wherein the one or more collaborators include specialists whose advice is sought.

13. A digital images management system for a mobile device having both a camera capable of taking digital images and an ability to communicate with the internet, the management system comprising:
an internet schema resident on the internet, the internet schema having multiple data fields that are searchable to extract information based upon a common characteristic found in one of the multiple data fields;
a mobile device schema resident in the mobile device, the mobile device schema having multiple data fields that mirror the multiple data fields of the internet schema, the multiple data fields of the mobile device schema being updated to correspond with the multiple data fields of the internet schema whenever the mobile device connects with the internet schema on the internet;
a graphical user interface resident in the mobile device that allows a user to:
input, into the mobile device schema, metadata descriptive of the subject of a digital image contemporaneously with taking of the digital image, the metadata in the mobile device schema being independent of the digital image, but linked to the digital image for future recall;
upload, along with each digital image, the metadata linked to the digital image from the mobile device schema to the internet schema; and
grant permission for one or more collaborators to access selected portions of the internet schema to view selected digital images and the metadata linked to such digital images.
